(19) United States
(12) Patent Application Publication
(10) Pub. No.: US 2011/0287138 A1
(43) Pub. Date: Nov. 24, 2011

(54) SYSTEM AND METHOD FOR FREEZE DRYING FOOD ARTICLES

(76) Inventor: Alexander Malinsky, Glenview, IL (US)

(21) Appl. No.: 13/111,743

(22) Filed: May 19, 2011

Related U.S. Application Data
(60) Provisional application No. 61/346,337, filed on May 19, 2010.

(51) Int. Cl. A23L 1/29; A23L 1/20; A23L 1/10; A23L 1/36

(52) U.S. Cl. 426/61

(57) ABSTRACT

A method for enhancing nutritional value of a food article, the method comprising soaking the food article for a first predetermined time period, sprouting the food article for a second predetermined time period so as to facilitate activation of live enzymes in the food article, and freeze drying the food article so as to reach a predetermined moisture content of the food article.

### CROSS-REFERENCE TO RELATED APPLICATIONS

This patent application claims the benefit of U.S. Provisional Patent Application No. 61/346,337 filed May 19, 2010, which is incorporated herein by reference in its entirety, including without limitation all drawings and figures therein.

### FIELD OF THE INVENTION

This invention relates generally to the field of food processing and more specifically to food processing associated with nutrition-enhanced food articles.

### BACKGROUND OF THE INVENTION

Live enzyme foods provide dramatically more nutrition and energy to the body. Existing research on the benefits of live enzyme foods shows an important relationship whereby food enzymes aid digestive enzymes, which, in turn, support and build metabolic enzymes. Metabolic enzymes help the body's cells perform their functions. Such research further shows that metabolic enzymes diminish without a replenishment of food enzymes and that a key difference between younger and older people is their levels of metabolic enzymes. For example, broccoli sprouts have three to ten times more of the various cancer preventing compounds found in mature broccoli.

### BRIEF SUMMARY OF THE INVENTION

Embodiments of the invention are used to provide a method for enhancing nutritional value of a food article such as by activating and preserving the benefits of live enzyme activity in the food article. The method comprising soaking the food article in a soaking solution for a first predetermined time period, sprouting the food article for a second predetermined time period so as to facilitate activation of live enzymes in the food article, and freeze drying the food article so as to reach a predetermined moisture content of the food article. Freeze drying ensures preservation of high activity.

In another aspect of the invention, a method for enhancing nutritional value of a food article is provided. The method comprising soaking the food article in a soaking solution for a first predetermined time period comprising a range of at least approximately 8 to 24 hours, wherein the soaking solution is maintained within a temperature range of approximately 68° F. to 77° F. The method further comprises sprouting the food article for a second predetermined time period comprising a range of at least approximately 12 to 24 hours so as to facilitate activation of live enzymes in the food article, and freeze drying the food article so as to reach a predetermined moisture content of the food article, the predetermined moisture content comprising a range of approximately 3 to 5 percent.

In yet another aspect of the invention, a nutrition-enhanced edible product is provided, wherein the nutrition-enhanced edible product is manufactured via the steps comprising soaking a food article in a soaking solution for a first predetermined time period, sprouting the food article for a second predetermined time period so as to facilitate activation of live enzymes in the food article, and freeze drying the food article so as to reach a predetermined moisture content of the food article. In various embodiments, the food article is a nut, a seed, a legume, or a grain, among others.

### BRIEF DESCRIPTION OF THE DRAWINGS

While the appended claims set forth the features of the present invention with particularity, the invention and its advantages are best understood from the following detailed description taken in conjunction with the accompanying drawings, of which:

FIG. 1 is a diagram illustrating an embodiment of food processing equipment and associated steps for manufacturing a nutrition-enhanced edible product via various embodiments of the method further described in FIGS. 3-10;

FIG. 2 is a diagram illustrating another embodiment of food processing equipment and associated steps for manufacturing a nutrition-enhanced edible product via various embodiments of the method further described in FIGS. 3-10; and

FIGS. 3-10 are flow charts illustrating various embodiments of a method for enhancing nutritional value of a food article in accordance with respective embodiments of the present invention.

### DETAILED DESCRIPTION

The following examples further illustrate the invention but, of course, should not be construed as in any way limiting its scope.

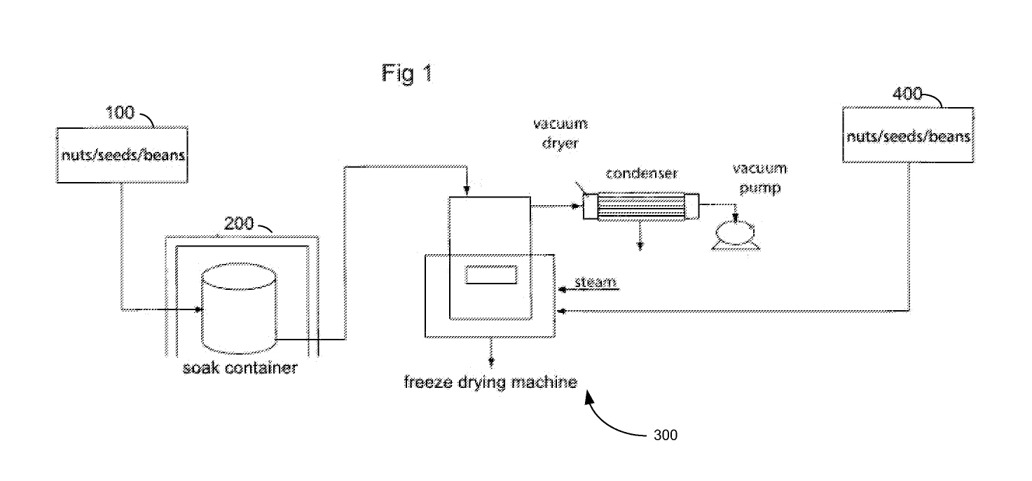

Embodiments of the invention comprise a process that enhances nutritional value of a food article, such as a nut, a seed, or a legume (e.g., a bean, a pea, or the like), by retaining or locking the enzymes therein. With reference to FIG. 1, an embodiment of the food processing equipment and associated steps in connection with the below described process is shown. In an embodiment, conveyor 100 receives a plurality of nuts, seeds or beans. Step 200 shows the plurality of nuts, seeds, or beans being soaked. Step 300 shows the plurality of nuts, seeds or beans being freeze dried. Step 400 shows the finished product.

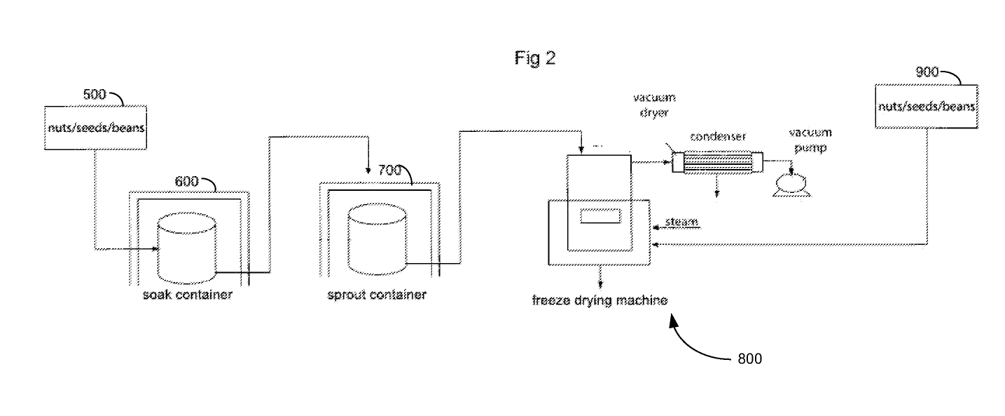

In FIG. 2, another embodiment of the equipment for manufacturing a nutrition-enhanced edible product via various embodiments of the below described method is shown. In one embodiment, conveyor 500 receives a plurality of nuts, seeds and/or beans. Step 600 shows the plurality of nuts, seeds or beans being soaked. Step 700 shows the nuts, seeds or beans being sprouted. Step 800 shows the plurality of nuts, seeds or beans being freeze dried. Step 900 shows the finished product.

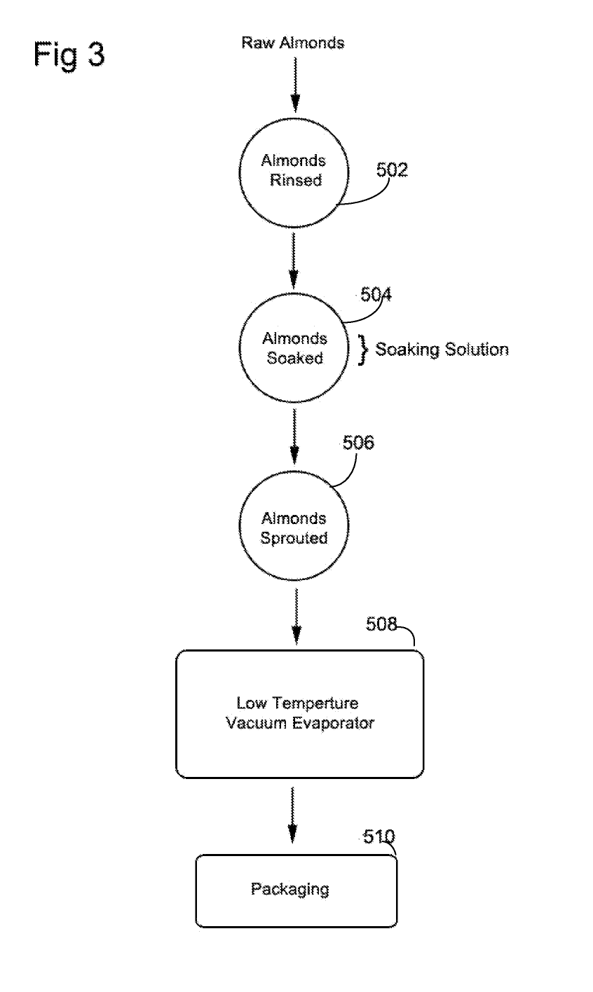

With reference to FIG. 3, an embodiment of a method for enhancing nutritional value of a food article is shown. In an embodiment of FIG. 3, in Step 502, a plurality of nuts, for example almonds, are rinsed and cleaned from any debris or dust. Step 504 begins with soaking the almonds in a soaking solution. Preferably, the almonds are soaked for at least 8-10 hrs. In this case we will use pure water. During this process, the water is optionally flavored with any spices and/or seasonings. In an embodiment, a mineral solution is added to enrich or enhance the nutritional content of the food being soaked.

Step 506 involves sprouting the almonds. Preferably, the almonds are sprouted for at least 12-24 hrs. During sprouting, processes in the dormant seed or grain start converting storage protein and carbohydrates into active enzymes and vitamins. Sprouting converts a seed or nut into an active vegetable where proteins, vitamins and phyto-chemicals increase 3-5 times. Because sprouts are loaded with enzymes they are easily digested.

Step 508 involves freeze drying the almonds until a moisture content of 3-5% is met. Optionally, before freeze drying, we can leave the product as is or season it with sea salt or any other spices or sweeteners. Step 510 involves sorting and packaging the almonds in air-tight bags ready for resell.

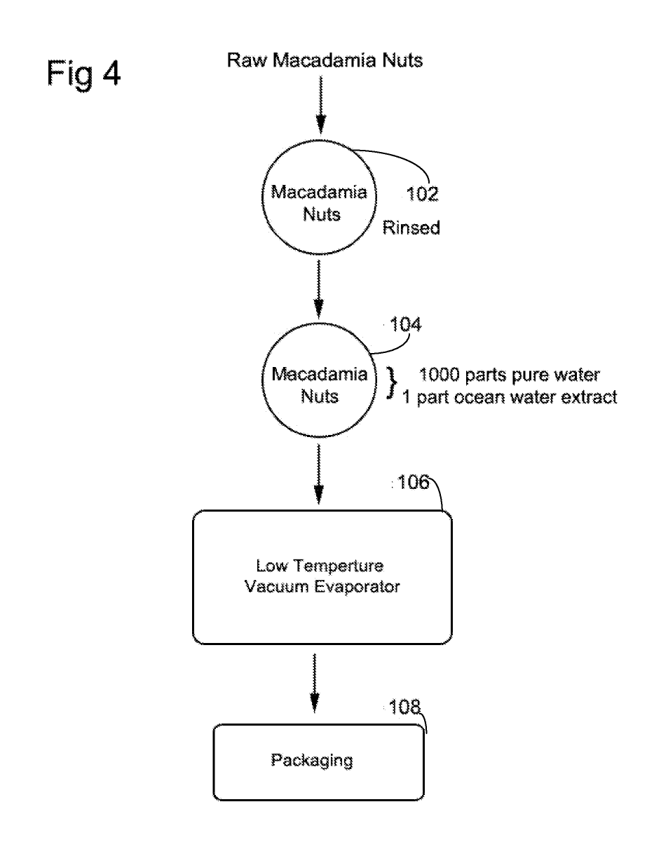

In an embodiment depicted in FIG. 4, in Step 102, a plurality of nuts, for example macadamia nuts, are rinsed and cleaned from any debris or dust. Step 104 begins with soaking the macadamia nuts in a soaking solution for at least 8-10 hrs. In this example, an embodiment of the soaking solution comprises 1000 parts pure water with 1 part ocean water extract. Step 106 involves freeze drying the macadamia nuts until a moisture content of 3-5% is met. Optionally before freeze drying, we can season the product with sea salt or any other spices or sweeteners before it goes into the freeze drying process. Step 108 involves sorting and packaging the macadamia nuts in air-tight bags ready for resell.

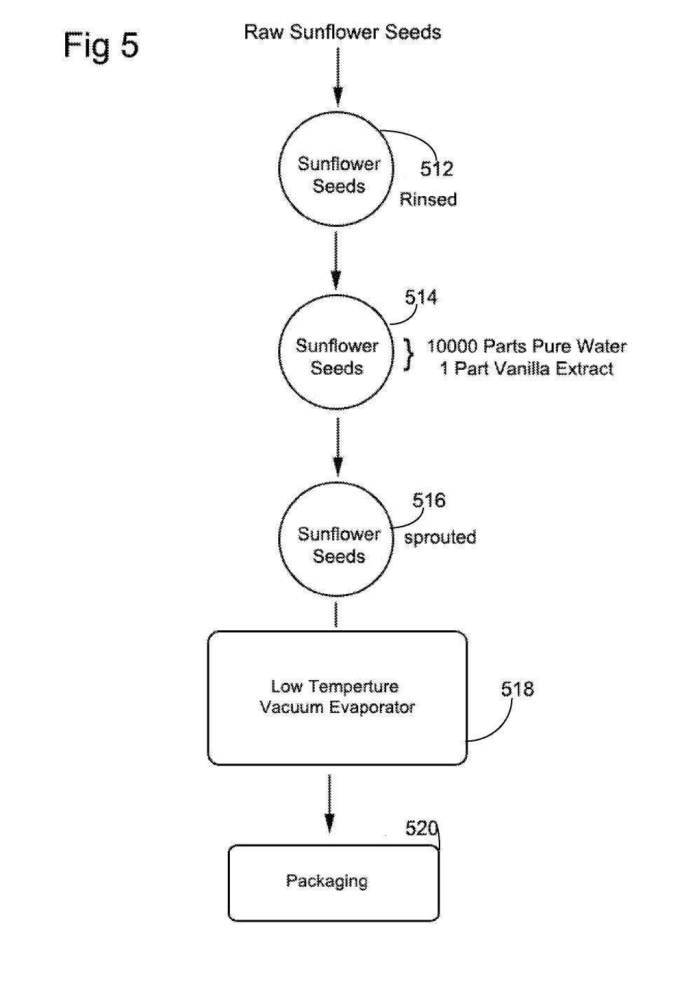

In an embodiment depicted in FIG. 5, in Step 512, a plurality of seeds, for example sunflower seeds, are rinsed and cleaned from any debris or dust. Step 514 begins with soaking the sunflower seeds in a soaking solution comprising, for instance, 10000 parts water to 1 part vanilla extract for at least 8-10 hrs.

Step 516 involves sprouting the sunflower seeds for at least 12-24 hrs. During sprouting, processes in the dormant seed or grain start converting storage protein and carbohydrates into active enzymes and vitamins. Sprouting converts a seed or nut into an active vegetable where proteins, vitamins and phyto-chemicals increase 3-5 times.

Step 518 involves freeze drying the sunflower seeds until a moisture content of 3-5% is met. Before freeze drying, we can leave the product as is or season it with sea salt or any other spices or sweeteners. Step 520 involves sorting and packaging the almonds in air-tight bags ready for resell.

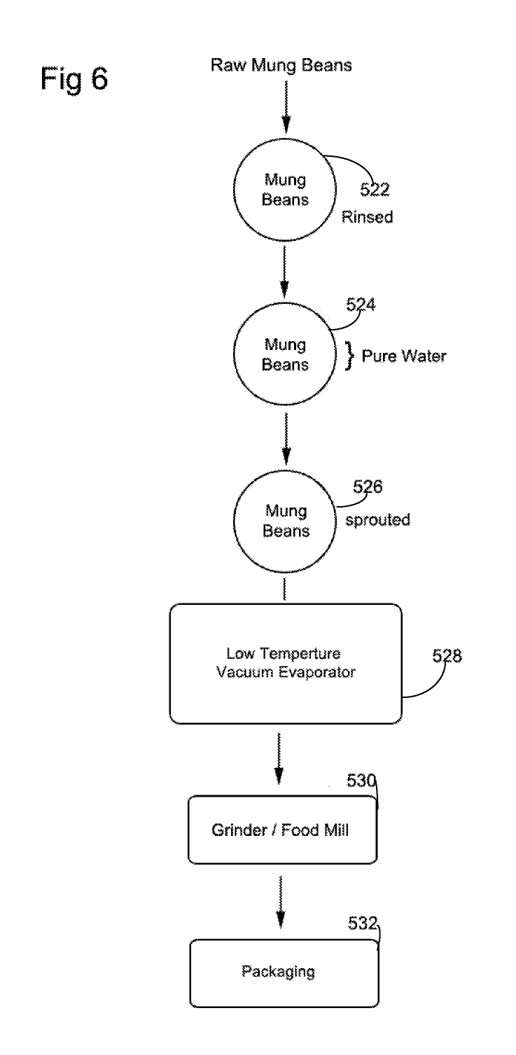

In an embodiment depicted in FIG. 6, in Step 522, a plurality of legumes, for example mung beans, are rinsed and cleaned from any debris or dust. Step 524 begins with soaking the mung beans in pure water for at least 12-24 hrs. Step 526 involves sprouting the mung beans for at least 12-24 hrs. During sprouting, processes in the dormant seed or grain start converting storage protein and carbohydrates into active enzymes and vitamins. Sprouting converts a seed or nut into an active vegetable where proteins, vitamins and phyto-chemicals increase 3-5 times. Step 528 involves freeze drying the mung beans until a moisture content of 3-5% is met. Before freeze drying, we can leave the product as is or season it with sea salt or any other spices or sweeteners. Step 530 involves grinding the mung beans until a desired predetermined texture is reached. Step 532 involves sorting and packaging the mung bean flour in air tight bags ready for resell.

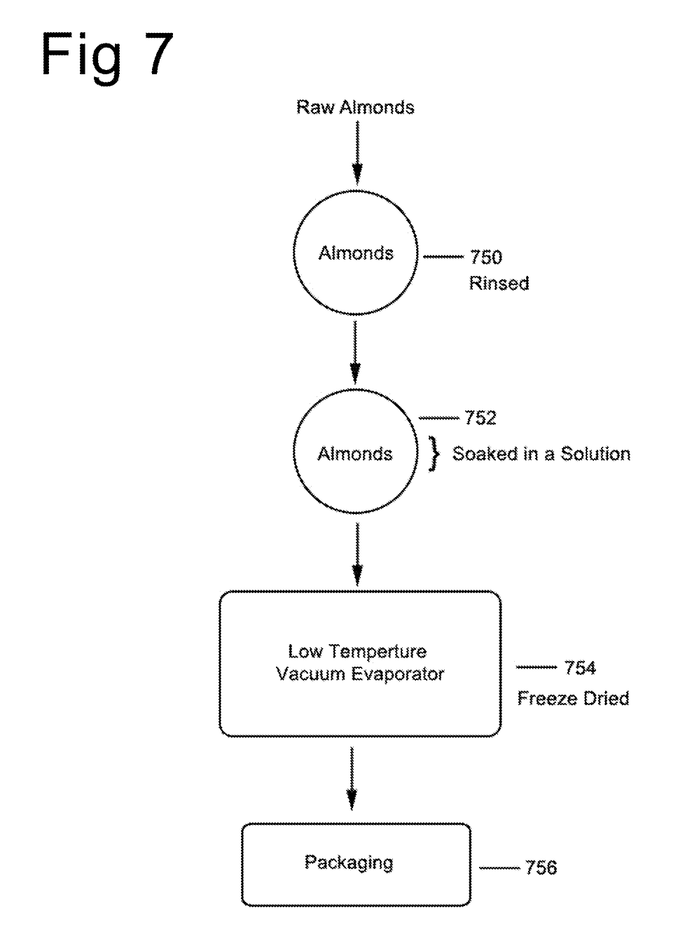

With reference to FIG. 7, in step 750, nuts, such as almond nuts, are rinsed. In step 752 the nuts are soaked in a soaking solution, such as wine. In alternative embodiments, the soaking solution is any one or more of tea, sea vegetable solution, medicinal mushroom solution, kombucha, essential oil solution, vinegar solution, coffee, coconut water, sugar solution, vegetable juice, beer, fruit juice, milk, or oil, such as vegetable or fruit oil. In an embodiment, the nuts are soaked for 12-24 hours at 68° F. to 77° F. Next, in step 754, the nuts are deposited in a freeze drier. In step 756, the finished product is processed by the packaging equipment.

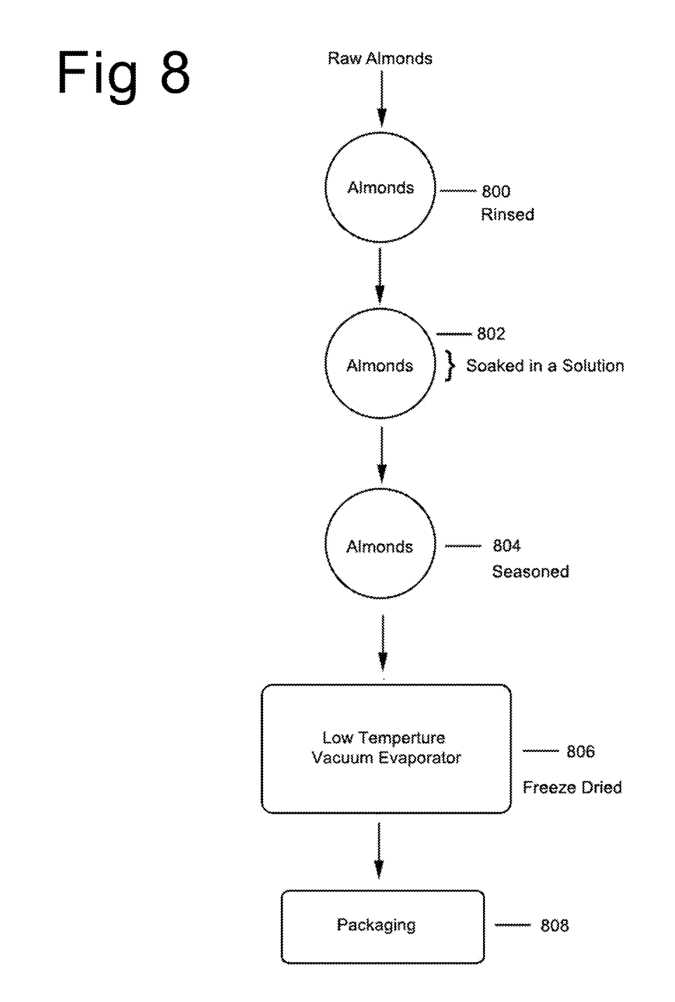

With reference to FIG. 8, in step 800, nuts, such as almond nuts, are rinsed. In step 802 the nuts are soaked in a soaking solution, such as water. In an embodiment, the soaking solution is spring water. In an embodiment, the nuts are soaked for 12-24 hours at 68° F. to 77° F. In step 804, the nuts are seasoned, with seasonings, such as one or more of sea salt, pepper, nutritional yeast, chocolate, vanilla, fruit powders, vegetable powders, mushrooms, herbal blends, or a probiotic blend. Next, in step 806, the nuts are deposited in a freeze drier. In step 808, the finished product is processed by the packaging equipment.

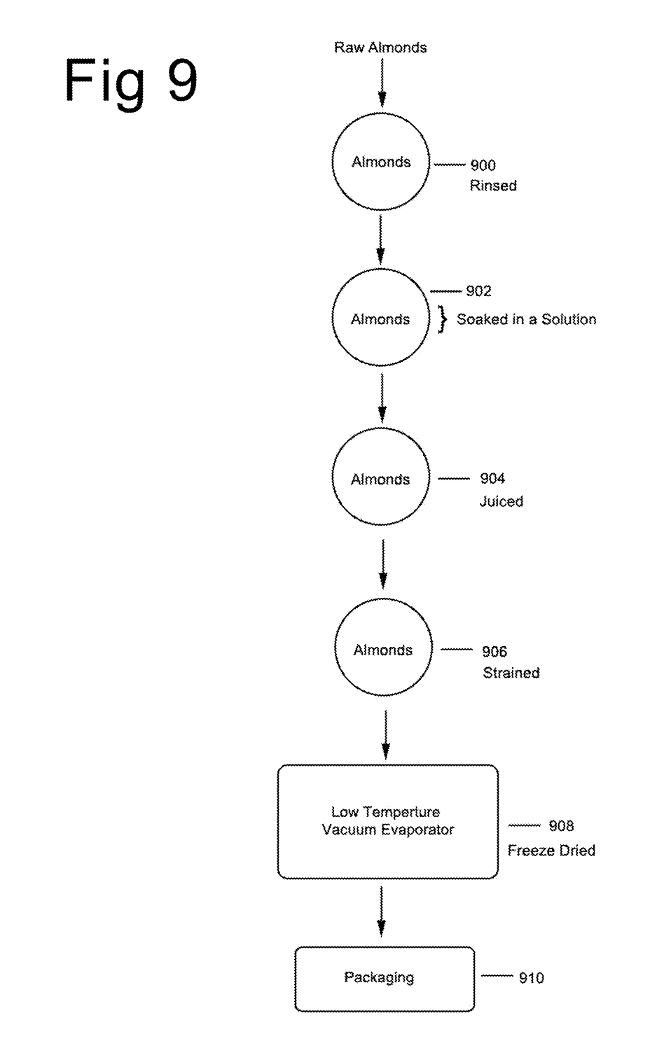

With reference to FIG. 9, in step 900, nuts, such as almond nuts, are rinsed. In step 902, the nuts are soaked in a soaking solution, such as water. In an embodiment, the nuts are soaked for 12-24 hours at 68° F. to 77° F. In step 904, the nuts are juiced. In step 906, the nuts are strained. Next, in step 908 the nut juice/milk is deposited in a freeze drier. In step 910, the finished product is processed into powder by the packaging equipment.

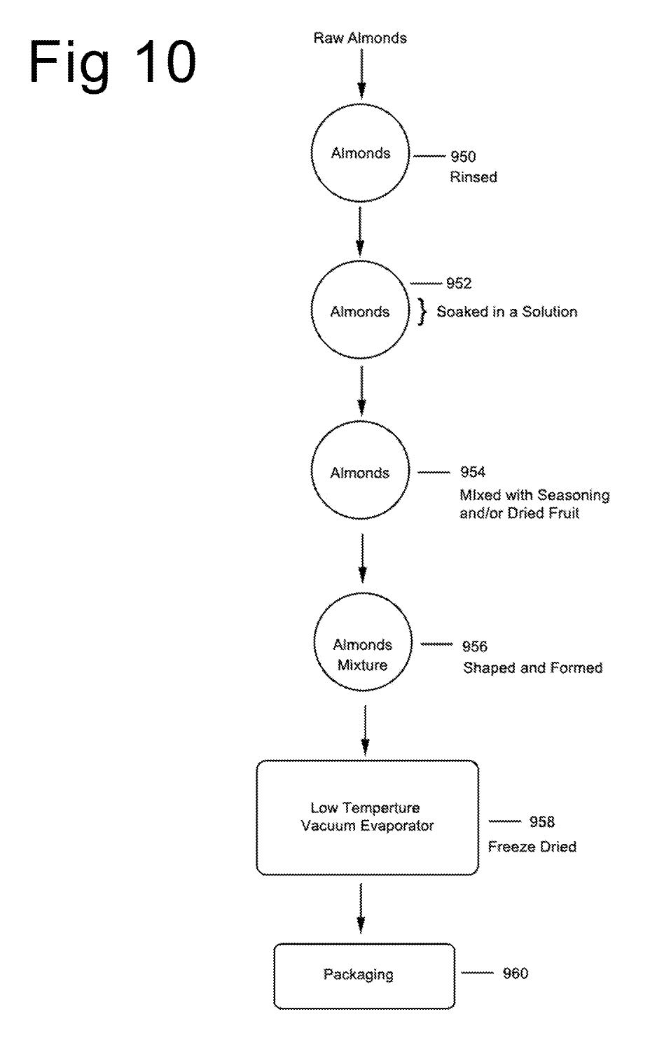

With reference to FIG. 10, in step 950, nuts, such as almond nuts, are rinsed. In step 952, the nuts are soaked in a soaking solution, such as water. In an embodiment, the nuts are soaked for 12-24 hours at 68° F. to 77° F. In step 954, the nuts are mixed with seasoning and/or dried fruit. In step 956, the nut mixture is formed into granola, cereal, bars or cookies. Next, in step 958, the formed creation is deposited in a freeze drier. In step 960, the finished product is packed by the packaging equipment.

Those skilled in the art will understand that the foregoing description is not limited to particular examples of nuts, seeds, and/or legumes discussed above and generally applies to enhancing the nutritional value of food articles that are capable of activating live enzymes and other nutrition-enhancing processes therein via soaking and/or sprouting. As discussed above, freeze drying ensures preservation of high activity.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for enhancing nutritional value of a food article, the method comprising:
soaking the food article in a soaking solution for a first predetermined time period comprising a range of at least approximately 8 to 24 hours, wherein the soaking solution is maintained within a temperature range of approximately 68° F. to 77° F.;
sprouting the food article for a second predetermined time period comprising a range of at least approximately 12 to 24 hours so as to facilitate activation of live enzymes in the food article; and
freeze drying the food article so as to reach a predetermined moisture content of the food article, the predetermined moisture content comprising a range of approximately 3 to 5 percent.

2. A method for enhancing nutritional value of a food article, the method comprising:
soaking the food article in a soaking solution for a first predetermined time period;
sprouting the food article for a second predetermined time period so as to facilitate activation of live enzymes in the food article; and
freeze drying the food article so as to reach a predetermined moisture content of the food article.

3. The method of claim 2 wherein the first and second predetermined time periods are the same.

4. The method of claim 2 wherein the first and second predetermined time periods are different.

5. The method of claim 2 wherein the first predetermined time period comprises a range of approximately 8 to 24 hours.

6. The method of claim 2 wherein the second predetermined time period comprises a range of approximately 12 to 24 hours.

7. The method of claim 2 wherein the predetermined moisture content comprises a range of approximately 3 to 5 percent.

8. The method of claim 2 wherein the food article is a nut.

9. The method of claim 2 wherein the food article is a seed.

10. The method of claim 2 wherein the food article is a legume.

11. The method of claim 2 wherein the food article is a grain.

12. The method of claim 7 wherein the food article is selected from the group consisting of a nut, a seed, a legume, and a grain.

13. The method of claim 2 wherein the soaking solution is maintained at a predetermined temperature.

14. The method of claim 13 wherein the predetermined temperature comprises a range of approximately 68° F. to 77° F.

15. The method of claim 2 wherein the soaking solution comprises purified water.

16. The method of claim 2 wherein the soaking solution comprises a predetermined ratio of purified water to ocean water extract.

17. The method of claim 2 wherein the soaking solution comprises a predetermined ratio of purified water to vanilla extract.

18. The method of claim 2 wherein the soaking solution is selected from the group consisting of wine, tea, sea vegetable solution, medicinal mushroom solution, kombucha, essential oil solution, vinegar solution, coffee, coconut water, sugar solution, vegetable juice, beer, fruit juice, milk, and oil.

19. The method of claim 2 further comprising seasoning the food article prior to the freeze drying step.

20. A nutrition-enhanced edible product manufactured via the steps comprising:
soaking a food article in a soaking solution for a first predetermined time period;
sprouting the food article for a second predetermined time period so as to facilitate activation of live enzymes in the food article; and
freeze drying the food article so as to reach a predetermined moisture content of the food article.

21. The nutrition-enhanced edible product of claim 20 wherein the food article is selected from the group consisting of a nut, a seed, a legume, and a grain.
